(19) United States
(12) Patent Application Publication
(10) Pub. No.: US 2012/0136733 A1
(43) Pub. Date: May 31, 2012

(54) TECHNIQUES FOR SECURE CREDIT CARD TRANSACTIONS

(75) Inventor: Timothy Edward Mason, Buford, GA (US)

(73) Assignee: NCR Corporation, Duluth, GA (US)

(21) Appl. No.: 12/956,717

(22) Filed: Nov. 30, 2010

(51) Int. Cl. G06Q 40/00; G06Q 30/00; G06Q 20/00

(52) U.S. Cl. 705/16; 705/44; 705/27.1

(57) ABSTRACT

A consumer registers a credit card at a point-of-sale device for additional security. The point-of-sale device does not require the additional security for processing credit card transactions. Subsequently, when the consumer presents the credit card at the point-of-sale device for a particular credit card transaction, the additional security is provided by the consumer and verified before the credit card and the particular credit card transaction is permitted to be sent to a card processor associated with the credit card.

### BACKGROUND

Consumers are increasingly using kiosks to conduct business with enterprises. The kiosks come in a variety of sizes and are used for a variety of purposes. Some kiosks are drive through, such as fast food establishments, pharmacies, banks, and the like. Other kiosks are stationary located in gas stations, airlines, grocery stores, department stores and the like.

In addition to this level automation transforming the industry, consumers are performing more and more transactions using their credit cards via kiosks, via on-line purchases, and via in-person and store-manned purchases. In fact, many people no longer carry cash and rely almost entirely on their credit cards for purchases.

However, with these new levels of automation also comes a dramatic increase in identity theft. In fact, identity (ID) theft is a serious concern for the modern consumer. A self-checkout system at the point-of-sale (POS) for a retailer potentially provides an attractive outlet for an identity thief to use illegally obtained credit cards or cloned credit cards created from stolen credit card data. Such a self-checkout system may be viewed by the ID thief as providing a method to use a stolen or fraudulent card with little or no direct observation by the retailer's checkout staff.

Debit cards are not really credit cards because funds come directly from a consumer's checking or savings account at the time of purchase. Moreover, debit cards often do not offer the same level of insurance protection that credit cards do. That is, credit cards often provide a maximum amount of unauthorized purchases that a consumer is responsible for, such as $50. Conversely, there is usually not such protection with debit cards and because the debit card is tied to a checking or savings account of a consumer, a consumer's cash funds can be quickly depleted with unauthorized actions of a thief. Therefore, consumers are not as enthusiastic about using debit cards. Most consumers prefer credit cards and when there is unauthorized use it is usually the store or enterprise that bears the majority of the loss and not the consumer or the card processor.

Consequently, both consumers and merchants have a vested interest in improving credit card transactions against ID theft.

### SUMMARY

In various embodiments, techniques for secure credit card transactions are presented. According to an embodiment, a method for registration and processing of secure credit card transactions is provided.

A credit card is detected, during a transaction, as being used by a consumer. The consumer is asked to register the credit card for security protection by entering a consumer-defined personal identification number (PIN). Next, the PIN with the credit card of the consumer is registered. Finally, the consumer is requested to enter the PIN to complete subsequent transactions when using the credit card at locations where a PIN is not required for the use of the credit card.

### BRIEF DESCRIPTION OF THE DRAWINGS

FIG. 1 is a diagram of a method for secure credit card transactions, according to an example embodiment.

FIG. 2 is a diagram of another method for secure credit card transactions, according to an example embodiment.

FIG. 3 is a diagram of a secure credit card transaction system, according to an example embodiment.

### DETAILED DESCRIPTION

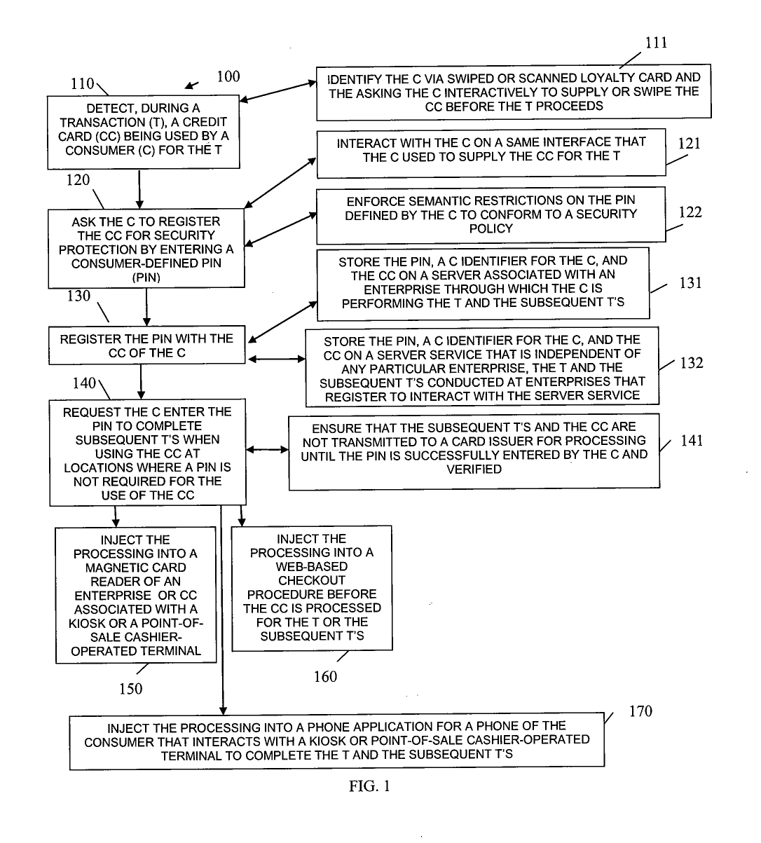

FIG. 1 is a diagram of a method 100 for secure credit card transactions, according to an example embodiment. The method 100 (hereinafter “secure credit card registration and transaction service”) is implemented as instructions programmed and residing on a non-transitory computer-readable (processor-readable) storage medium and executed by one or more processors. The processors are specifically configured and programmed to process the secure credit card registration and transaction service. The secure credit card registration and transaction service operates over a network. The network is wired, wireless, or a combination of wired and wireless.

Cloud computing is often defined as computing capabilities that provide an abstraction between computing resources and the underlying technical architecture (e.g., servers, storage, networks), enabling convenient, on-demand network access to a shared pool of configurable computing resources that can be rapidly provisioned and released with minimal management effort or service provider interaction. From the perspective of the user, where and how a computing resource is obtained is irrelevant and is transparent in cloud computing.

As used herein a “cloud processing environment” refers to a set of cooperating computing resources, such as machines, storage, software libraries, software systems, etc. that form a logical computing infrastructure.

At 110, the secure credit card registration and transaction service detects, during a purchasing transaction, a credit card being used by a consumer for that transaction. Here, credit card is being used synonymously with credit card number or the information encoded on a magnetic strip, chip, or other machine-readable media of a physical card.

Additionally, it is noted that some cards can function as a dual credit card or debit card based on selections made by a consumer at the start of a transaction. In these cases, the selection made by the consumer is a credit card, which does not require any PIN for usage and which is safer for the consumer to use since a bank or checking account of the consumer is not being accessed for the credit card transaction. Therefore, it is noted that usage of the term “credit card” does not include a debit card and does not include a dual card that is selected to function in debit card mode. However, in some cases, the credit card as used herein can refer to a gift credit card that is pre-loaded with a pre-defined amount. So, credit card can refer to visa and master card gift cards herein.

According to an embodiment, at 111, the secure credit card registration and transaction service identifies the consumer, via a swiped, scanned loyalty card or entered loyalty, and then the secure credit card registration and transaction service interactive asks the consumer to supply or swipe the credit card before the transaction proceeds. In this instance, the secure credit card registration and transaction service immediately detects once the consumer is identified via a loyalty card that the consumer does not have a credit card on file that is registered and asks the consumer before proceeding to supply the credit card either via a swipe or manual entry via an input device. It may also be that a dual functioning card serves as both the loyalty card and credit card, in such a case the card is swiped once in the loyalty mode to identify the customer and then swiped in the credit card mode.

At 120, the secure credit card registration and transaction service asks the consumer to register the credit card for security protection by entering a consumer-defined and provided personal identification number (PIN).

In an embodiment, at 121, the secure credit card registration and transaction service interact with the consumer on a same interface that the consumer used to supply the credit card for the transaction. So, if the credit card is supplied via a magnetic card swiping device and associated display, the consumer is interacted with via the magnetic card swiping device and associated display.

In still another case, at 122, the secure credit card registration and transaction service enforces semantic restrictions on the PIN defined and provided by the consumer for purposes of conforming the format of the PIN to what is defined in a security policy. For example, the security policy may require that the PIN be no less than 4 digits, not include a birth date of the consumer, and the like.

At 130, the secure credit card registration and transaction service registers the PIN with the credit card of the consumer. So, whenever the credit card is detected the PIN is required before the transaction can complete, as described in more detail below.

In one case, at 131, the secure credit card registration and transaction service stores the PIN, a consumer identifier for the consumer, and the credit card on a server associated with an enterprise through which the consumer is performing the transaction or the subsequent transactions. In other words, processing of the secure credit card registration and transaction service is enterprise specific and controlled and managed within a secure enterprise network of the enterprise.

Alternatively, at 132, the secure credit card registration and transaction service stores the PIN, a consumer identifier for the consumer, and the credit card on a server service that is independent of any particular enterprise. So, the transaction and the subsequent transactions are conducted at enterprises that register to interact and communicate with the server service. Here, the secure credit card registration and transaction service includes a client-based application processing at each of the registered enterprises and a service-based application processing on the server service. When an enterprise registers with the server service, the client-based application is downloaded, installed, and initiated on credit card processing devices of that registered enterprise. This permits the secure credit card registration and transaction service to function as an independent service offered to consumers and enterprises, perhaps on a transactional fee bases, periodic fee bases, or flat fee bases.

At 140, the secure credit card registration and transaction service requests that the consumer enter the PIN to complete subsequent transactions when using the credit card at locations where a PIN is not required for the user of credit cards. That is, the credit card processing device and/or credit card processor does not require a PIN for typical and normal usage of the credit card (the consumer card is a credit card or in credit card mode for a dual-functioning card). However, a PIN is being required by integrating the processing of the secure credit card registration and transaction service into the normal processing flow of handling credit card transactions.

According to an embodiment, at 141, the secure credit card registration and transaction service ensures that the subsequent transactions and the credit card are not transmitted to a card processor associated with the credit card and for normal credit card processing until the PIN is successfully entered by the consumer and verified by the secure credit card registration and transaction service. Therefore, no transaction is capable of successfully completing unless a successful PIN is entered and no credit card (encoded information on the physical card) is exposed to a network wire unless the PIN was successfully entered.

In one scenario, at 150, the processing of the secure credit card registration and transaction service is injected and integrated into a magnetic card reader of an enterprise. The magnetic card reader associated with a self-service kiosk or a point-of-sale cashier operated terminal. Also, at 150, the processing may be integrated and integrated into a chip on the credit card of the consumer, when the credit card is equipped with a chip on the credit card.

In another case, at 160, the processing of the secure credit card registration and transaction service is injected into a web-based checkout procedure before the credit card is processed for the transaction or the subsequent transaction. Thus, the secure credit card registration and transaction service can be integrated into checkout portals associated with on-line purchasing transactions at enterprises.

In yet another situation, at 170, the secure credit card registration and transaction service is injected into a portable computing device application for a portable computing device of the consumer. The portable computing device interacts with a kiosk or point-of-sale cashier-operated terminal to complete the transaction and the subsequent transactions. Here, a portable computing device enabled to complete merchant credit card transactions includes some portion of the secure credit card registration and transaction service to ensure that the PIN is entered and verified before the credit card transaction is permitted to complete.

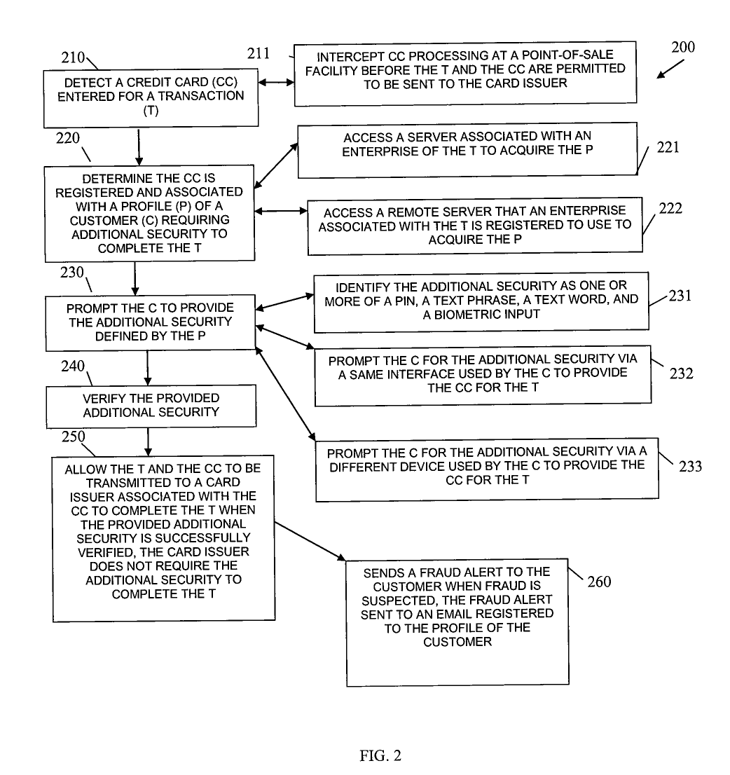

FIG. 2 is a diagram of another method 200 for secure credit card transactions, according to an example embodiment. The method 200 (hereinafter “secure credit card transaction service”) is implemented as instructions and programmed within a non-transitory computer-readable (processor-readable) storage medium that executes on one or more processors on a server or a cloud processing environment; the processors of the server or cloud processing environment are specifically configured to execute the secure credit card transaction service. The secure credit card transaction service is operational over a network; the network is wired, wireless, or a combination of wired and wireless.

The secure credit card transaction service provides another and in some ways enhanced perspective of the secure credit card registration and transaction service represented by the method 100 of the FIG. 1. The processing of the secure credit card transaction service assumes that the credit card registration processing (discussed with the method 100 of the FIG. 1) has been completed as a precursor to the processing of the secure credit card transaction service.

At 210, the secure credit card transaction service detects a credit card for a transaction. Again, a credit card as used herein refers to the encoded information on a physical card of a customer. If that physical card can function as a dual credit card or debit card than the credit card mode was selected by the customer, such that it is being used to access a card processor to complete a purchasing transaction and not a bank or checking account of the customer. Additionally, it is noted that as used herein the term “customer” may be used interchangeably and synonymously with the term “consumer” (as used above with the description of the method 100 of the FIG. 1).

According to an embodiment, at 211, the secure credit card transaction service intercepts the normal credit card processing at a point-of-sale facility or device before the transaction and the credit card (encoded information) is capable of being sent to the card processor for the credit card.

At 220, the secure credit card transaction service determines that the credit card is registered and associated with a profile of the customer, thereby requiring additional security to complete the transaction. Registration can occur in the manners discussed above with respect to the method 100 of the FIG. 1.

In an embodiment, at 221, the secure credit card transaction service access a server associated with an enterprise of the transaction to acquire the profile. So, the profile is managed within a secure network of the enterprise and the processing of the secure credit card transaction service is self contained within that secure network.

In an alternative case, at 222, the secure credit card transaction service accesses a remote server that an enterprise associated with the transaction is registered to use for purposes of the secure credit card transaction service acquiring the profile. Here, portions of the secure credit card transaction service process on devices of the enterprise (client-based device applications) and other portions process remotely over a secure network that the enterprise client-side application interfaces with. In this embodiment, the secure credit card transaction service is enterprise independent meaning that multiple different enterprises can access the profile and require the additional security of the customer before completing a purchasing transaction.

At 230, the secure credit card transaction service prompts the customer to provide the additional security defined by the profile. So, as an enhancement to the processing discussed above with the method 100 of the FIG. 1. The customer, via the profile, can custom define what exact additional security is required to be inputted by the customer and verified by the secure credit card transaction service before the purchasing transaction is permitted to complete.

For example, at 231, the secure credit card transaction service can evaluate the profile to identify the additional security as one or more items of information, including but not limited to: a PIN, a text phrase, a text word (such as a password comprising any combination of characters), and/or a biometric input (such as a finger print, a retinal scan, a facial scan (scans could be provided via a camera of a customer's portable computing device), and the like).

In an embodiment, at 232, the secure credit card transaction service prompts the customer for the additional security defined via the profile via a same interface used by the customer to provide the credit card for the transaction (such as a magnetic card swipe device and the like).

Alternatively, at 233, the secure credit card transaction service prompts the customer for the additional security via a different device used by the customer to provide the credit card for the transaction. For example, the customer may swipe the card at a magnetic swiping device and receive a prompt on the customer's portable computing device to provide the additional security defined by the profile.

At 240, the secure credit card transaction service verifies the provided additional security by comparing what is inputted by the customer to what is defined in the registered profile of the customer.

At 250, the secure credit card transaction service allows the transaction and the credit card (encoded information on the physical credit card) to be transmitted to the card processor associated with the credit card for purposes of completing the transaction when the provided additional security is successfully verified, at 240. It is noted that the card processor does not require and is not expecting the additional security to complete the transaction; the additional security is enforced via the secure credit card transaction service without knowledge or interaction by the card processor systems.

In an embodiment, at 260, the secure credit card transaction service sends a fraud alert to the customer when fraud is suspected, the fraud alert sent to an email registered to the profile of the customer.

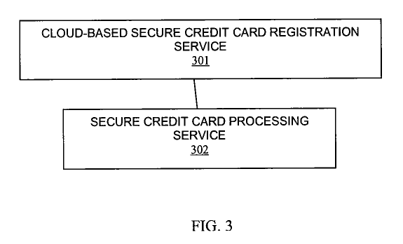

FIG. 3 is a diagram of a secure credit card transaction system 300, according to an example embodiment. The secure credit card transaction system 300 includes one or more processors that are specifically configured to perform, inter alia, the processing associated with the methods 100 and 200 of the FIGS. 1 and 2, respectively. The secure credit card transaction system 300 may also include a variety of other hardware components, such as network adapters, memory, display screen(s), input mechanisms, and the like. Furthermore, the secure credit card transaction system 300 is operational over a network and the network can be wired, wireless, or a combination of wired and wireless.

The secure credit card transaction system 300 includes one or more processors in a cloud-processing environment having a cloud-based secure credit card registration service 301 and a point of sale device having a secure credit card processing service 302. Each of these and their interactions with one another will now be discussed in turn.

The cloud-based secure credit card registration service 301 resides and is programmed in a non-transitory computer-readable storage medium and executes on the one or more processors of the cloud processing environment.

The point-of-sale device is configured with the secure credit card processing service 302, which is programmed in a non-transitory computer readable medium of the point-of-sale device and executes on the point-of-sale device.

The cloud-based secure credit card registration service 301 and the secure credit card processing service 302 are both configured to interact with one another over a network to register credit cards of consumers for additional security and to enforce the additional security during transactions with the credit cards at the point-of-sale device.

Example processing associated with the cloud-based secure credit card registration service 301 and the secure credit card processing service 302 were provided in detail above with reference to the methods 100 and 200 of the FIGS. 1 and 2, respectively.

According to an embodiment, the point-of-sale device is a magnetic credit card swipe device, a server of an enterprise used for on-line transactions, and/or a portable computing device of a particular customer.

In another situation, the secure credit card processing service 302 is configured to not provide the credit cards (encoded information on the physical cards of the consumer) to card processors until the additional security is verified by the cloud-based secure credit card registration service 301.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A processor-implemented method programmed in a non-transitory processor-readable medium and to execute on one or more processors configured to execute the method, comprising:
detecting, during a transaction, a credit card being used by a consumer for the transaction;
asking the consumer to register the credit card for security protection by entering a consumer-defined personal identification number (PIN);
registering the PIN with the credit card of the consumer; and
requesting the consumer enter the PIN to complete subsequent transactions when using the credit card at locations where a PIN is not required for the use of the credit card.

2. The method of claim 1 further comprising, injecting the method processing into a magnetic card reader of an enterprise associated with a kiosk or a point-of-sale cashier-operated terminal or injecting the method processing into a chip on the credit card.

3. The method of claim 1 further comprising, injecting the method processing into a web-based checkout procedure before the credit card is processed for the transaction or the subsequent transactions.

4. The method of claim 1 further comprising, injecting the method processing into a portable computing device application for a portable computing device of the consumer that interacts with a kiosk or point-of-sale cashier-operated terminal to complete the transaction and the subsequent transactions.

5. The method of claim 1, wherein detecting further includes identifying the consumer via swiped, scanned, and/or entered loyalty card and the asking the consumer interactively to supply or swipe the credit card before the transaction proceeds.

6. The method of claim 1, wherein asking further includes interacting with the consumer on a same interface that the consumer used to supply the credit card for the transaction.

7. The method of claim 1, wherein asking further includes enforcing semantic restrictions on the PIN defined by the consumer to conform to a security policy.

8. The method of claim 1, wherein registering further includes storing the PIN, a consumer identifier for the consumer, and the credit card on a server associated with an enterprise through which the consumer is performing the transaction and the subsequent transactions.

9. The method of claim 1, wherein registering further includes storing the PIN, a consumer identifier for the consumer, and the credit card on a server service that is independent of any particular enterprise, the transaction and the subsequent transactions conducted at enterprises that register to interact with the server service.

10. The method of claim 1, wherein requesting further includes ensuring that the subsequent transactions and the credit card are not transmitted to a card processor for processing until the PIN is successfully entered by the consumer and verified.

11. A processor-implemented method programmed in a non-transitory processor-readable medium and to execute on one or more processors configured to execute the method, comprising:
detecting a credit card entered for a transaction;
determining the credit card is registered and associated with a profile of a customer requiring additional security to complete the transaction;
prompting the customer to provide the additional security defined by the profile;
verifying the provided additional security; and
allowing the transaction and the credit card to be transmitted to a card processor associated with the credit card to complete the transaction when the provided additional security is successfully verified, the card processor does not require the additional security to complete the transaction.

12. The method of claim 11, wherein detecting further includes intercepting credit card processing at a point-of-sale facility before the transaction and the credit card are permitted to be sent to the card processor.

13. The method of claim 11, wherein determining further includes accessing a server associated with an enterprise of the transaction to acquire the profile.

14. The method of claim 11, wherein determining further includes accessing a remote server that an enterprise associated with the transaction is registered to use to acquire the profile.

15. The method of claim 11, wherein prompting further includes identifying the additional security as one or more of a personal identification number (PIN), a text phrase, a text word, and a biometric input.

16. The method of claim 11, wherein prompting further includes prompting the customer for the additional security via a same interface used by the customer to provide the credit card for the transaction or prompting the customer for the additional security via a different device used by the customer to provide the credit card for the transaction.

17. The method of claim 11 further comprising, sending a fraud alert to the customer when fraud is suspected, the fraud alert sent to an email registered to the profile of the customer.

18. A system, comprising:
one or more processors in a cloud-processing environment having a cloud-based secure credit card registration service, the cloud-based secure credit card registration service resides and is programmed in a non-transitory computer-readable storage medium and executes on the one or more processors of the cloud-processing environment; and
a point-of-sale device configured with a secure credit card processing service programmed in a non-transitory computer readable medium of the point-of-sale device and executing on the point-of-sale device;
the cloud-based secure credit card registration service and the secure credit card processing service configured to interact with one another over a network to register credit cards of consumers for additional security and to enforce the additional security during transactions with the credit cards at the point-of-sale device.

19. The system of claim 18, wherein the point-sale-device is one of: a magnetic credit card swipe device, a server of an enterprise used for on-line transactions, and a portable computing device of a particular consumer.

20. The system of claim 18, wherein the secure credit card processing service is configured to not provide the credit cards to card processors until the additional security is verified by the cloud-based secure credit card registration service.
